(19) United States
(12) Patent Application Publication
(10) Pub. No.: US 2002/0157243 A1
(43) Pub. Date: Oct. 31, 2002

(54) Component installer and extractor

(76) Inventors: Vernon Bollesen, Milpitas, CA (US); Peter Cuong Dac Ta, Hayward, CA (US)

Correspondence Address: SUN MICROSYSTEMS, INC, 901 San Antonio Road MS UPAL01-521, Palo Alto, CA, 94303, US

(21) Appl. No.: 09/845,441

(22) Filed: Apr. 30, 2001

(51) Int. Cl. B23P 19/00

(52) U.S. Cl. 29/758; 29/739

(57) ABSTRACT

An apparatus for installing and extracting a component on a printed circuit board includes an adjustable body having a first angled edge and a second angled edge. The first angled edge is formed with a flange engageable with a bottom surface of the component. The second angled edge is formed with a hook extending beyond the second angled edge. The hook is engageable with the bottom surface of the component. The adjustable body may include a first tab and second tab extending therefrom. The first and second tabs are moved toward each other to adjust the adjustable body within a range of positions.

### RELATED APPLICATION

This application is related to application Ser. No. ______, pending, entitled “Apparatus and Method for Installing and Extracting Components on a Printed Circuit Board” which is assigned to the assignee of the present application and filed concurrently herewith.

### BACKGROUND OF THE INVENTION

1. Field of the Invention

The present invention relates generally to components on a printed circuit board, and more specifically to installing and extracting such components.

2. Background Information

As computer systems become increasingly sophisticated, their internal components often become smaller and more densely situated. For example, a printed circuit board (PCB), such as a motherboard, for a computer system may have numerous integrated circuits disposed on the surface of the PCB. Adjacent integrated circuits are placed close to one another to take advantage of the entire surface area of the PCB. Although integrated circuits are often installed on a PCB by machines, some components may be installed by a user. However, because of the dense grouping of integrated circuits and other components on a PCB, it is difficult to manually install a component that is to be located adjacent another component. Furthermore, it may be necessary to remove the component if it is damaged or needs to be upgraded, and removing the component can be as problematic as installing the component because of the space constraints. Manually installing and extracting a component can also subject the component to undesirable forces.

### SUMMARY OF THE INVENTION

An apparatus for moving a component of a computer system comprises an adjustable body with a first angled edge and a second angled edge. The first angled edge has a flange which is engageable with a bottom surface of the component. The second angled edge has a hook which extends beyond the second angled edge. The hook is engageable with the bottom surface of the component. In one embodiment, a first tab and a second tab extend from the adjustable body. The first and second angled edges of the adjustable body are moved relative to each other when the first and second tabs are moved toward each other.

Additional features and benefits of the present invention will become apparent from the detailed description, figures and claims set forth below.

### BRIEF DESCRIPTION OF THE DRAWINGS

Various embodiments of the present invention will be described in detail with reference to the following drawings. The present invention is illustrated by way of example and not limitation in the accompanying figures.

FIG. 1A illustrates a perspective view of one embodiment of an adjustable claw engaged with a component in accordance with the teachings of the present invention.

FIG. 1B illustrates an exploded view of the adjustable claw shown in FIG. 1A.

FIG. 2 illustrates a side view of an adjustable claw engaged with a component in accordance with the teachings of the present invention.

FIG. 3A illustrates a perspective view of one part of an adjustable claw in accordance with the teachings of the present invention.

FIG. 3B illustrates a perspective view of another part of an adjustable claw in accordance with the teachings of the present invention.

FIG. 4 illustrates a perspective view of another embodiment of an adjustable claw engaged with a component in accordance with the teachings of the present invention.

### DETAILED DESCRIPTION

The description and accompanying drawings are for purposes of illustration and are not to be used to construe the invention in a restrictive manner. In the following description, specific details are set forth in order to provide a thorough understanding of the invention. However, it will be apparent to one of ordinary skill in the art that the invention can be practiced without these specific details. In particular, the invention will be described with specific reference to memory modules, but it is appreciated that the invention is not limited to use with any one component.

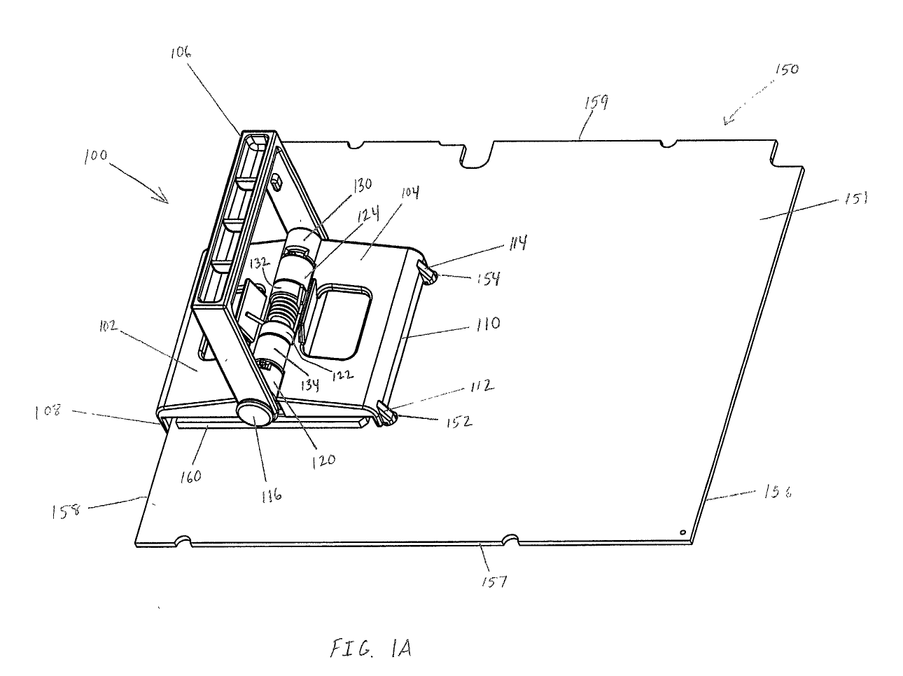

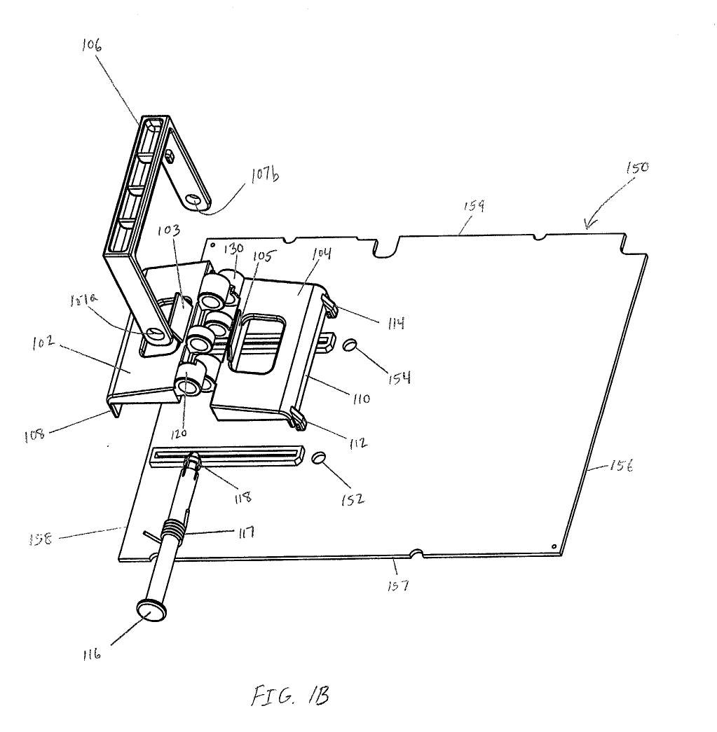

FIGS. 1A and 1B illustrate a perspective view and an exploded view, respectively, of one embodiment of an adjustable claw engaged with a component according to the present invention. Adjustable claw 100 includes an adjustable body formed with a first claw member 102 and a second claw member 104. The undersides of members 102 and 104 are formed with a recessed or hollow area to accommodate subcomponents or raised features on a top surface 151 of component 150 when claw 100 is engaged with component 150. Component 150 may be a memory module or other component of a computer system.

Claw 100 also includes an adjustable handle 106. Members 102 and 104 and handle 106 are independently rotateable about a common axis which is the longitudinal axis of a pin 116. Members 102 and 104, handle 106 and spring 117 are held together by pin 116 which is inserted through through-holes of member 102, member 104, handle 106, and spring 117. Head 118 of pin 116 prevents pin 116 from slipping out of through-hole 107b once head 118 is pushed through through-hole 107b. Head 118 is tapered to facilitate pushing head 118 through through-holes 107a and 107b, which are slightly smaller than the widest part of the tapered area of head 118. Members 102 and 104, handle 106 and pin 116 may be made from plastic or any suitably rigid material.

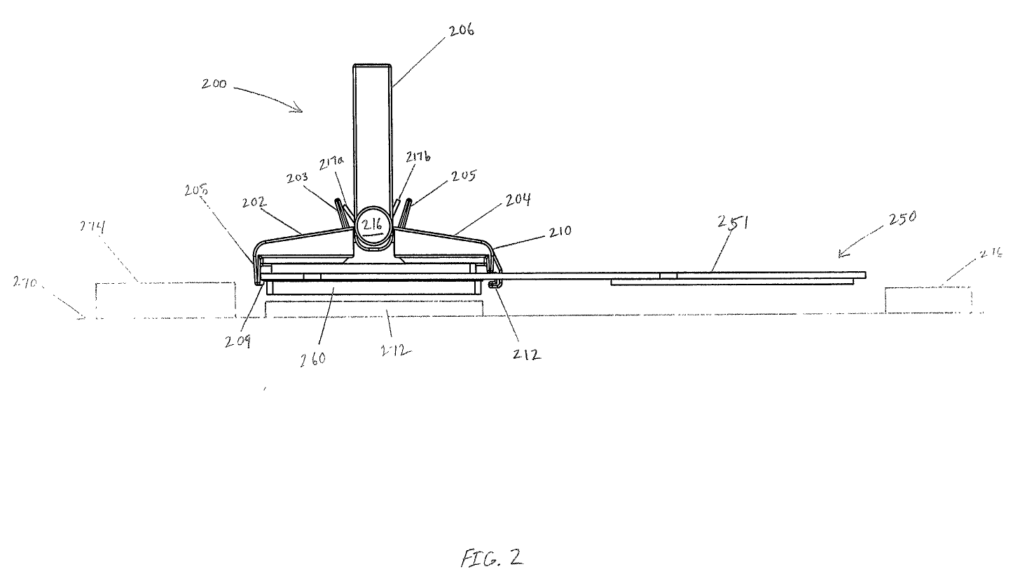

Member 102 has an angled edge 108 from which a flange (not shown) extends. Member 104 has an angled edge 110 from which hooks 112 and 114 extend. The flange of angled edge 108 and hooks 112 and 114 engage the bottom surface or underside of component 150 in a manner similar to that shown in FIG. 2 (see flange 209 and hook 212). Thus, hooks 112 and 114 are placed through through-holes 152 and 154, respectively, of component 150. It is appreciated that through-holes 152 and 154 may need to be formed in component 150 to accommodate hooks 112 and 114 because preexisting holes in component 150 may not be positioned or sized appropriately. Alternatively, the hooks may be formed to fit preexisting holes in component 150. When claw 100 engages component 150 using the flange of angled edge 108 and hooks 112 and 114, angled edge 108 abuts edge 158 of component 150 and the bottom of angled edge 110 abuts top surface 151 of component 150.

Because claw 100 grabs component 150 at an edge of component 150 and an interior area of component 150, claw 100 is less likely to subject component 150 to potentially damaging bending forces during extraction of component 150. If component 150 is a large memory module, then grabbing component 150 at edges 156 and 158 or edges 157 and 159 may subject component 150 to potentially damaging bending forces during extraction of component 150.

Members 102 and 104 engage each other to permit the insertion of pin 116 while limiting their range of rotation around pin 116. Specifically, member 102 is formed with eyelets 120, 122 and 124 which are lined up with eyelets 134, 132 and 130 of member 104 in an alternating manner. Thus, eyelet 134 is located between eyelets 120 and 122, eyelet 132 is located between eyelets 122 and 124, and eyelet 130 is located adjacent eyelet 124. Spring 117 is located between eyelets 122 and 132. Eyelet 134 has a protrusion which engages a groove in eyelet 120. Eyelet 124 has a protrusion which engages a groove in eyelet 130. The grooves define the range of movement of the protrusions. Accordingly, members 102 and 104 have a limited range of rotation around pin 116.

Members 102 and 104 are formed with tabs 103 and 105, respectively, which allow a user to open claw 100 by concurrently pushing tabs 103 and 105 toward each other. Opening claw 100 disengages claw 100 from component 150. By concurrently pushing tabs 103 and 105 toward each other, claw 100 may be symmetrically adjustable. Spring 117 resists the movement of tabs 103 and 105 toward each other. Opposite ends of spring 117 press against tabs 103 and 105 to push tabs 103 and 105 away from each other. Thus, spring 117 forces claw 100 to a securing position (as limited by the grooves in eyelets 120 and 130) which securely engages component 150.

FIG. 2 illustrates a side view of a claw 200 engaging a component 250. Claw 200 may be viewed in FIG. 2 as completing installation of component 250 on printed circuit board 270 or beginning extraction of component 250. In either situation, the space between components 274 and 276 on printed circuit board 270 is just large enough to accommodate component 250 coupled to socket 272 via connector 260. The gaps between the edges of component 250 and components 274 and 276 may not be large enough for a user to grab component 250 with his or her fingers and install/extract component 250 without damaging neighboring components 274 and 276. Grabbing component 250 by its edges is not a suitable alternative because doing so could subject component 250 to undesirable bending stresses.

Claw 200 includes an adjustable body having a first claw member 202 and a second claw member 204. Members 202 and 204 are formed with tabs 203 and 205, respectively, which allow a user to open claw 200 by concurrently pushing tabs 203 and 205 toward each other. A spring having ends 217a and 217b resists the movement of tabs 203 and 205 toward each other. Spring ends 217a and 217b press against tabs 203 and 205 to push tabs 203 and 205 away from each other. Thus, claw 200 is biased to a securing position. The undersides of members 202 and 204 may be formed with a recessed or hollow area to accommodate subcomponents or raised features of component 250 when claw 200 is engaged with component 250. Claw 200 also includes an adjustable handle 206. Members 202 and 204 and handle 206 are independently rotateable about a common axis which is the longitudinal axis of a pin 216. Members 202 and 204 and handle 206 are held together by pin 216. Members 202 and 204, handle 206 and pin 203 may be made from plastic or any suitably rigid material.

Member 202 has an angled edge 208 from which a flange 209 extends. Angled edge 208 is positioned adjacent an edge of component 250 such that flange 209 may engage the underside of component 250. Member 204 has an angled edge 210 from which a hook 212 extends. Angled edge 210 is positioned along a top surface 251 of component 250 such that hook 212 may be placed through a through-hole in component 250. It is appreciated that angled edge 210 may have more than one hook and component 250 may be formed with a corresponding number of through-holes. In one embodiment, flange 209 is centered along the width of angled edge 208. Additionally, flange 209 may extend orthogonally from angled edge 208 to better engage the underside of component 250.

Because angled edge 208 of claw 200 has a thin profile, it can be positioned adjacent component 274 to engage the underside of component 250 with flange 209. When claw 200 is engaged with component 250, there is clearance between claw 200 and component 274 to move claw 200 laterally during installation/extraction of component 250. Thus, claw 200 may be used to provide safer installation/extraction of component 250.

To install component 250 on printed circuit board 270 using claw 200, component 250 is engaged by claw 200 and then positioned over printed circuit board 270 such that connector 260 is positioned over socket 272. Once component 250 is properly positioned, claw 200 is pushed down until connector 260 mates securely with socket 272. Claw 200 is then disengaged from component 250. To extract component 250 from printed circuit board 270 using claw 200, component 250 is engaged by claw 200 and then pulled out of socket 272 by pulling on handle 206.

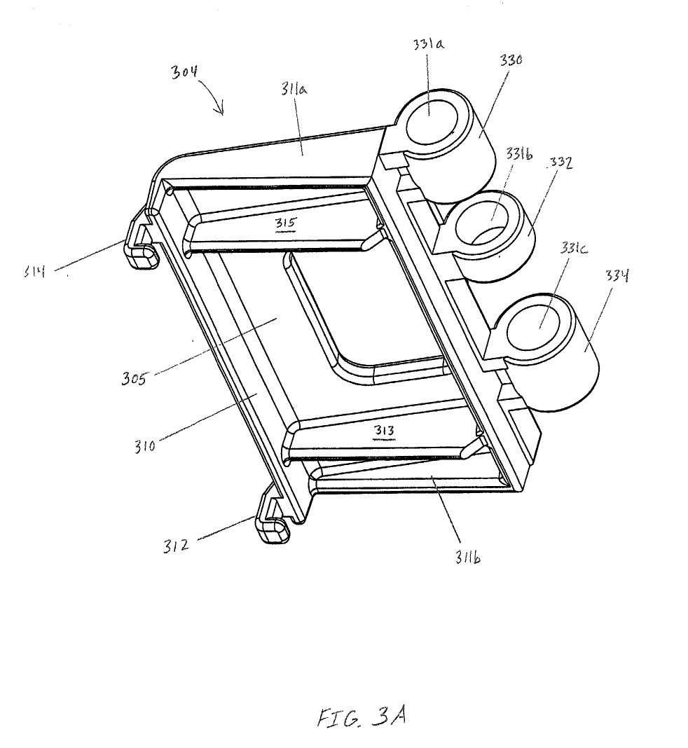

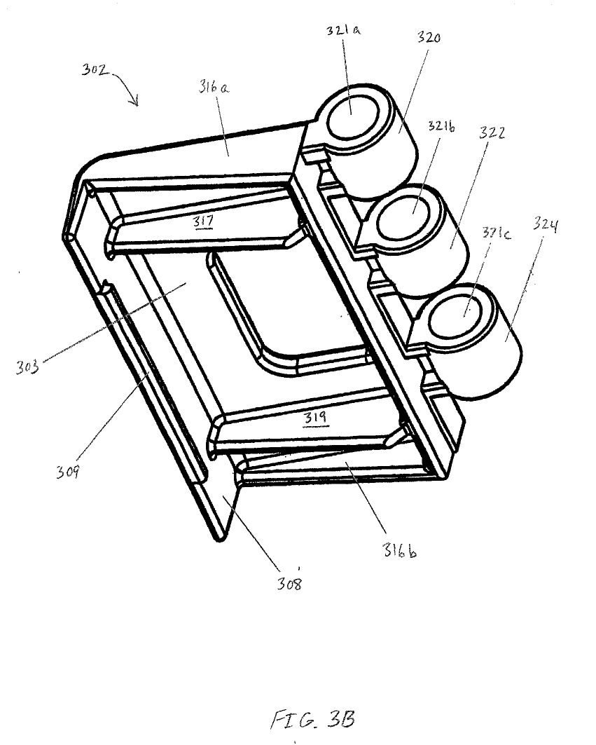

FIG. 3A illustrates a perspective view of an embodiment of a claw member which may be used in conjunction with claw member 302 shown in FIG. 3B to form an adjustable claw according to the present invention. Claw member 304 is integrally formed with eyelets 330, 332 and 334 which have through-holes 331a, 331b and 331c, respectively. Through-holes 331a, 331b and 331c are aligned with one another. Eyelet 330 may be formed with a groove, such as the groove in eyelet 130 shown in FIG. 1A, and eyelet 334 may be formed with a protrusion, such as the protrusion of eyelet 134. Hooks 312 and 314 extend from an angled edge 310 of claw member 304. It should be noted that hooks 312 and 314 extend beyond the bottom of angled edge 310 such that they may be placed through through-holes in a component and engage the underside of the component.

Partitions 313 and 315 extend from an inner surface 305 of claw member 304. The area bounded by partitions 313 and 315 and inner surface 305 provides room to accommodate a subcomponent or other raised feature on the surface of the component being engaged. Panels 311a and 311b maybe sized such that the bottom edges of panels 311a and 311b press down on a component when the component is being installed. The bottom of angled edge 310 may also press down on the component during installation. Furthermore, partitions 313 and 315 may be used, in addition to or alternatively to panels 311a and 311b, to press down on the component during installation.

FIG. 3B illustrates a perspective view of an embodiment of a claw member which may be used in conjunction with claw member 304 shown in FIG. 3A to form an adjustable claw according to the present invention. Claw member 302 is integrally formed with eyelets 320, 322 and 324 which have through-holes 321a, 321b and 321c, respectively. Through-holes 321a, 321b and 321c are aligned with one another. Eyelet 320 may be formed with a groove, such as the groove in eyelet 120 shown in FIGS. 1A and 1B, and eyelet 324 may be formed with a protrusion, such as the protrusion of eyelet 124. A flange 309 extends from an angled edge 308 of claw member 302. In one embodiment, flange 309 is integrally formed with angled edge 308. It is appreciated that flange 309 may be longer or shorter as necessary to securely engage the underside of a component.

Partitions 317 and 319 extend from an inner surface 303 of claw member 302. The area bounded by partitions 317 and 319 and inner surface 303 provides room to accommodate a subcomponent or other raised feature on the surface of the component being engaged. Panels 316a and 316b may be sized such that the bottom edges of panels 316a and 316b press down on a component when the component is being installed. Furthermore, partitions 317 and 319 may be used, in addition to or alternatively to panels 316a and 316b, to press down on the component during installation.

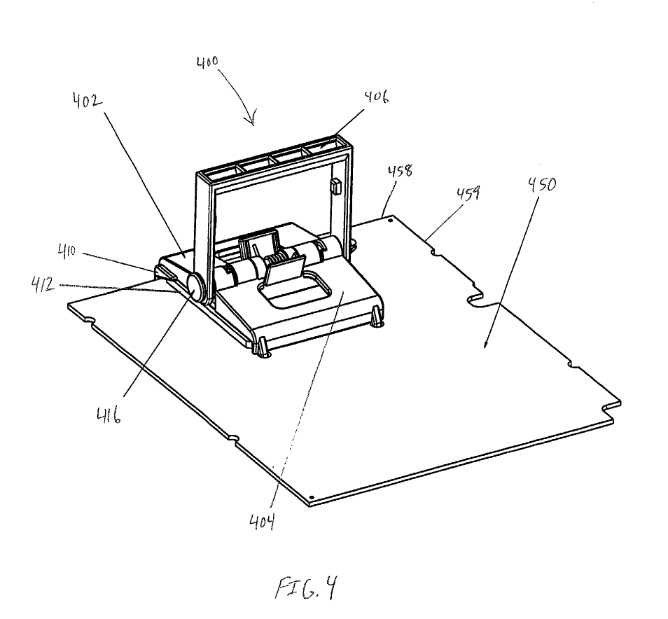

FIG. 4 illustrates a perspective view of another embodiment of an adjustable claw according to the present invention. Adjustable claw 400 is similar to adjustable claw 100 shown in FIGS. 1A and 1B. Member 402 is formed with a flange 410. Flange 410 helps prevent member 402 from inadvertently shifting its position along edge 458 of component 450 once claw 400 is engaged with component 450. For example, if member 402 shifts toward edge 459 of component 450, flange 410 contacts subcomponent 412 and prevents any further movement of member 402 toward edge 459. A second flange may be formed on the side of member 402 opposite flange 410. This second flange may prevent movement of member 402 away from edge 459.

In the foregoing detailed description, the present invention has been described with reference to specific exemplary embodiments. However, it will be evident that various modifications and changes may be made without departing from the broader scope and spirit of the present invention. For example, an adjustable claw according to the present invention may have a flexible one-piece body rather than a two-piece body which is rotateable about a pin. The present specification and figures are accordingly to be regarded as illustrative rather than restrictive.

What is claimed is:

1. An apparatus for moving a component of a computer system, the apparatus comprising:
an adjustable body;
a first angled edge of said adjustable body, said first angled edge comprising a flange engageable with a bottom surface of the component; and
a second angled edge of said adjustable body, said second angled edge comprising a hook extending beyond said second angled edge, wherein said hook is engageable with said bottom surface of the component.

2. The apparatus of claim 1, further comprising:
a first tab extending from said adjustable body; and
a second tab extending from said adjustable body;
wherein said first and second angled edges are moved relative to each other when said first and second tabs are moved toward each other.

3. The apparatus of claim 2, further comprising a spring abutting said first and second tabs, wherein said spring biases said first and second tabs away from each other.

4. The apparatus of claim 1, further comprising a handle coupled to said adjustable body.

5. The apparatus of claim 4, wherein said handle is adjustable independently from said adjustable body.

6. The apparatus of claim 1, wherein said adjustable body is configured to accommodate a subcomponent on the component when said adjustable body is engaged with the component.

7. The apparatus of claim 1, wherein said first angled edge of said adjustable body is adjacent a side edge of the component when said flange is engaged with said bottom surface of the component.

8. The apparatus of claim 7, wherein said second angled edge of said adjustable body is not adjacent a side edge of the component when said hook is engaged with said bottom surface of the component.

9. The apparatus of claim 1, wherein said hook is disposed through a through-hole in said component to engage with said bottom surface of the component.
